(19) United States
(12) Patent Application Publication
(10) Pub. No.: US 2019/0336259 A1
(43) Pub. Date: Nov. 7, 2019

(54) DENTAL CURING LIGHT SYSTEMS AND METHODS

(71) Applicant: 3M INNOVATIVE PROPERTIES COMPANY, St. Paul, MN (US)

(72) Inventors: Douglas L. Elmore, Plymouth, MN (US); Korbinian Gerlach, Gauting (DE); Gregory A. Kobussen, Woodbury, MN (US); Jack Wing Lai, Lake Elmo, MN (US); Joel D. Oxman, Minneapolis, MN (US); Rudolf Schmid, Eichenau (DE); Stefan K. Welker, Geltendorf (DE)

(21) Appl. No.: 16/319,415

(22) PCT Filed: Jul. 26, 2017
(86) PCT No.: PCT/IB2017/054546

§ 371 Date: Jan. 21, 2019

Related U.S. Application Data
(60) Provisional application No. 62/368,335, filed on Jul. 29, 2016.

(51) Int. Cl. A61C 13/15; C08F 2/48

(52) U.S. Cl. CPC A61C 19/004; C08F 2/48

(57) ABSTRACT

Dental curing light systems capable of monitoring the degree of curing of polymerizable dental material. A monitoring light source delivers visible monitoring light at one or more different visible wavelengths and a visible light detector detects the monitoring light diffusely reflected by the polymerizable dental material. The monitoring light has a wavelength of maximum emission (λmax-mon) that does not effectively induce polymerization of the polymerizable dental material. Change in intensity of the monitoring light reflected from the polymerizable dental material is used to determine when a selected degree of curing is reached in the polymerizable dental material.

### FIELD OF THE INVENTION

This invention relates generally to dental curing light systems and methods of curing polymerizable dental material.

### BACKGROUND

Selectively polymerizable dental materials are used in oral care for, e.g., the restoration and/or formation of teeth.

One challenge in the use of at least some polymerizable dental materials is determining when a polymerizable dental material has completed or is nearing completion of the curing process. In some instances in which a polymerizable dental material can be cured using light, time and intensity of the curing light delivery may be used to gauge the curing process, with the assumption that exposure of the polymerizable dental material to light at a particular intensity in one or more wavelengths that causes the polymerizable dental material to cure and for a particular amount of time will result in an adequate degree of curing.

### SUMMARY

Dental curing light systems for and methods of curing and monitoring polymerizable dental material to determine the degree of curing of the polymerizable dental material are described herein.

“Polymerizable dental materials” that may be monitored for curing using the systems and/or methods described herein may include any monomers, oligomers, and/or polymers and combinations thereof which are capable of participating in a polymerization reaction. Generally, such monomers, oligomers, and/or polymers will include at least one reactive chemical group which participates (e.g., is consumed) in the polymerization reaction. Examples of such reactive chemical groups include, but are not limited to: ethylenically unsaturated groups such as (meth)acrylate groups, vinyl groups (e.g., including styryl groups and other α-olefinic groups), and acrylamide groups; ring-openable groups such as oxirane (i.e., epoxide) groups and aziridine groups; condensation reactive groups, such as carboxylic acid groups (and derivatives thereof, including but not limited to, acid halides groups, ester groups, activated ester groups, lactone groups, etc.), amine groups, alcohol groups, and the like; and other reactive chemical groups such as isocyanates. Examples of polymerization reactions, include but are not limited to, step growth polymerization reactions (including condensation polymerization reactions), e.g., such as those used to form polyesters, polyamides, polyacetals, etc. and chain-growth (i.e., addition) polymerization reactions such (meth)acrylate and olefin polymerization reactions. Also included are those polymerizable dental materials which may be polymerized via hydrometallation (e.g., hydrosilylation), or other methods such as olefin metathesis (e.g., ring opening metathesis polymerization, “ROMP”). The polymerized material resulting from the polymerization reaction may be a homopolymer or a copolymer. The polymerized material resulting from the polymerization reaction may include crosslinks.

The polymerizable dental materials can cure/polymerize under a variety of one or more conditions such that the polymerizable dental materials undergo one or more physical and/or chemical changes (e.g., hardness, viscosity, opacity, shade/color, tackiness, modulus of elasticity, flexibility, reactive group (e.g., (meth)acrylate or oxirane) content, etc.).

The polymerizable dental material may include an initiator to facilitate the polymerization reaction. The identity of the initiator can and will vary depending on the particular components of the polymerizable dental material. For example, polymerizable dental materials may include photoinitiators (e.g., phosphine oxides, etc.), thermal initiators (e.g., peroxides, hydroperoxides, peracetates, azo compounds, etc.), and/or other initiators (e.g., a redox initiator system including an oxidizing agent and reducing agent, etc.), and combinations of such initiators, to facilitate a polymerization reaction. In (meth)acrylate based polymerizable dental materials, the initiator typically serves to provide a source of free radicals to initiate the polymerization. Depending on the particular type of initiator used, or combination of initiators used, the polymerization reaction may be initiated by electromagnetic radiation (e.g., actinic radiation), by heating, and/or chemically to generate radical species. The polymerizable dental material may include multiple initiators. For example, some polymerizable dental materials may formatted as a two-part redox curable material, where one or both parts of the two-part system further includes a photoinitiator, such that the polymerizable dental material may be “dual cured.” In the case of some epoxide-based polymerizable dental materials, various catalysts may be used to cure the epoxy (e.g., amines, acids, acid anhydrides, phenols, alcohols, thiols, etc.).

In one or more embodiments of the systems and/or methods described herein, the polymerizable dental materials include one or more monomers, oligomers, polymers, or combinations thereof, where at least one of the one or more monomers, oligomers, or polymers include an ethylenically unsaturated group such as a (meth)acrylate group. In further embodiments, the polymerizable dental material includes a photoinitiator.

Examples of polymerizable dental materials that may be monitored for curing using the systems and/or methods described herein include, but are not limited to: restoratives, composites (e.g., filling materials), adhesives, cements (e.g., resin modified glass ionomer cements, luting cements), sealants, primers, cavity liners, crown and bridge materials (either permanent or temporary), coatings, impression materials, and the like. It is understood that the term “polymerizable dental materials” further includes those polymerizable materials which may be used as part of orthodontic treatment, such as orthodontic primers, orthodontic adhesives, orthodontic cements, orthodontic sealants, or other polymerizable materials which may be used to bond an orthodontic appliance (e.g., brackets, bands, etc.) to a tooth.

The systems and/or methods described herein are configured to determine when a selected degree of curing of polymerizable dental material is reached using visible monitoring light. As used herein, “degree of curing” (and variations thereof) means the amount of change in one or more physical and/or chemical properties (e.g., hardness, viscosity, opacity, shade/color, tackiness, modulus of elasticity, flexibility, reactive group (e.g., (meth)acrylate or oxirane) content, etc.) of the polymerizable dental material as a result of curing. As described herein, the degree of curing of polymerizable dental material can be determined based on changes in the intensity of visible monitoring light that is reflected from the polymerizable dental material during and/or after curing.

As used herein, “diffuse reflectance” (and variations thereof) is used broadly to refer to collimated light reflected from the polymerizable dental material at angles of reflection that do not equal the angle of incidence of the curing light and non-collimated light not returned to the visible light detector at angles solely through specular reflectance from the surface of the polymerizable dental material. Monitoring light delivered to the polymerizable dental material may be diffusely reflected to the visible light detector in a system and/or method described herein after undergoing multiple scattering events within the polymerizable dental material, such that the light interacts with numerous external and internal interfaces and regions of varying geometry, size, and complex refractive indices. In one or more embodiments, changes in the intensity of reflected monitoring light detected by the visible light detector before and after curing are not due to electronic, vibrational, or rotational resonance and a corresponding anomalous dispersion of the refractive index associated with a specific chemical functionality or moiety in any component of the polymerizable dental material (i.e., not an absorbing chromophore, such as C═C, epoxy, N—H, etc.).

The systems and methods described herein include a monitoring light source that delivers visible monitoring light at one or more different visible wavelengths and a visible light detector configured to detect the monitoring light diffusely reflected by the polymerizable dental material during a curing process. The monitoring light reflected from the polymerizable dental material during curing is used to determine when a selected degree of curing is reached in the polymerizable dental material. In one or more embodiments, the systems described herein may include a controller operably coupled to the visible light detector, with the controller being configured to determine when the polymerizable dental material reaches a selected degree of curing based at least in part on an output from the visible light detector. In one or more embodiments, the systems described herein may include a curing light source configured to emit curing light to cure the polymerizable dental material.

In one or more embodiments of the systems and/or methods described herein, the monitoring light source emits visible monitoring light (at, e.g., one or more wavelengths in a range from 400 nm to 800 nm) with one or more wavelengths of maximum emission, λₘₐₓ₋ₘₒₙ, that do not effectively induce polymerization (curing) of the polymerizable dental material. As used herein, “not effectively inducing polymerization” means that the one or more monitoring wavelengths of maximum emission, λₘₐₓ₋ₘₒₙ, of the monitoring light cause no appreciable change in the physical and/or chemical properties of the polymerizable dental material on which the monitoring light is incident for a period of 60 seconds or less as compared to the same polymerizable dental material under the same conditions that is not irradiated with the monitoring light.

In one or more embodiments of the systems and methods described herein, no wavelengths of light in the monitoring light emitted by the monitoring light source are absorbed by any polymerizable chemical moiety (e.g., an IR and/or near-IR absorbing chromophore, such as (meth)acrylate, epoxy, etc.) in the polymerizable dental material. In one or more alternative embodiments, any wavelengths of visible monitoring light that are detected and relied on to monitor the curing of any polymerizable dental material used in connection with the systems and/or methods as described herein are wavelengths that are not absorbed by any polymerizable chemical moiety in the polymerizable dental material. As a result, degree of curing of a polymerizable dental material using the visible monitoring light of one or more embodiments of the systems and/or methods described herein is not determined by detecting absorbance of one or more wavelengths of the visible monitoring light. Rather, the systems and/or methods described herein determine when polymerizable dental material reaches a selected degree of curing based on changes in the intensity of visible light reflected by the polymerizable dental material at one or more wavelengths.

Problems that may be addressed using the systems and methods described herein may include ensuring an adequate degree of curing. Determining the degree of curing may be particularly difficult in instances in which the polymerizable dental material is relatively thick (e.g., 1 mm or more, 2 mm or more, etc.) such as in, e.g., dental restorative materials located in tooth cavities, etc. To ensure an adequate degree of curing in, e.g., systems and methods used with polymerizable dental materials that cure through exposure to light, the curing light may, in some instances, be delivered for longer times and/or at higher intensities than required to reach that adequate degree of cure, resulting in slower processing and/or wasted energy. In still other instances, the polymerizable dental material may not be adequately cured if, for example, the curing light is delivered for a shorter time and/or lower intensity than required. In yet other instances, the curing light may be misdirected such that, although the curing light source may be activated for the required length of time, the intensity of the light that is actually incident on the polymerizable dental material is not sufficient for an adequate degree of curing.

In one or more embodiments, intensity of the reflected monitoring light changes as a function of the degree of curing due to the changing refractive index of polymerizable dental material as a function of level of cure. Monitoring the intensity of reflected visible monitoring light may be useful where, e.g., it is difficult or impossible to access the side of the polymerizable dental material opposite the surface on which the visible monitoring light is incident to measure transmittance of the monitoring light (e.g., dental composite material in a tooth, polymerizable dental materials located on opaque substrates, etc.).

In one or more embodiments, the systems and methods described herein may be capable of monitoring the degree of curing of polymerizable dental materials utilizing light scattering changes that occur during the curing or polymerization process, with the light scattering changes causing detectable changes in the intensity of the reflected monitoring light. For example, the monomers that undergo polymerization due to a change in chemical structure during the cure process may, in one or more embodiments, exhibit a change in refractive index. That change in refractive index may, in one or more embodiments, be directly correlated with the extent of polymerization of the reactive composition in the polymerizable dental material and, further, may be detectable using visible monitoring light due to changes in intensity of the reflected monitoring light as detected by a visible light detector as discussed herein.

In one or more embodiments, polymerizable dental materials that shift optical properties proportionally during the curing process may be combined with one or more materials (e.g., one or more fillers) that maintain a relatively constant refractive index. In such instances, the amount of light scattering may increase or decrease as a function of the increasing or decreasing change in of refractive index of the polymerizing matrix in the polymerizable dental material. Similarly, if during the curing process, phase separation occurs in polymerizable dental materials, then light scattering of the monitoring light may also change during the curing process—with the change in scattering resulting in a change in intensity of the reflected monitoring light as detected by a visible light detector.

One illustrative example of polymerizable dental materials that may be used with the systems and/or in the methods described herein are dental composites that are photopolymerized with, e.g., blue light in the range of approximately 400-500 nm. In one or more embodiments, the polymerizable dental composite material, which typically includes one or more fillers, would be probed or monitored for changes in scattering of the visible monitoring light as a function of curing time at a small and clinically relevant distance above the sample during the curing process.

The monitoring light sources used in the systems and/or methods described herein may, in one or more embodiments, deliver light at one or more wavelengths that are different and/or greater than wavelength(s) need to cure the polymerizable dental materials. There are several potential advantages for using monitoring light at different and/or longer wavelengths than the curing wavelengths.

One of the potential advantages is that the ability to detect light scatter at a wavelength different than incident curing wavelength may provide increased detection sensitivity. The ability to detect small changes in light scattering at the incident curing wavelengths may be challenging if, for example, the polymerizable dental material is light curable and the curing light is of a high intensity. In such circumstances, returning scattered monitoring light may be lost in the background noise of the incident curing light itself. Use of separate and distinct wavelength(s) for the monitoring light (along with a suitable detector) may enhance the detectability of small real time changes in scattering of the monitoring light. In one or more embodiments in which a curing light is blue light in the range of 400 nm-500 nm, a red light source (e.g., a laser or LED emitting light at approximately 650 nm) may, for example, be a useful monitoring light that is clear and distinct from the blue curing light.

A second potential advantage of using visible monitoring light at different wavelengths than the curing light wavelengths is visualization of the monitoring light. For example, monitoring light in the 600 nm-800 nm range can be easily visualized with the naked eye in the presence of a yellow/orange blue light filter that protects the eyes from glare caused by a blue curing light in the range of 400 nm-500 nm. The ability to see the monitoring light enables a user to see the location and placement of the curing light if, for example, the monitoring light is aligned with the curing light. In other words, the monitoring light may provide an aiming indicator to assist with accurate delivery of curing light to the polymerizable dental material to be cured.

A third potential advantage for, e.g., polymerizable dental materials that absorb light at wavelengths in or near the range of any curing wavelengths, is that the monitoring light would not be absorbed, thus making it available for, e.g., reflectance measurements. For example, most polymerizable dental composite materials are intended to provide an aesthetic restoration with optical properties similar to tooth structure. As a consequence, polymerizable dental composite materials often include varying amounts of yellow and red colored fillers/material that absorb light at wavelengths between approximately 400-550 nm. A monitoring source delivering monitoring light at longer wavelengths (e.g., greater than about 550 nm) would not be absorbed or compromised by these pigment additives.

A fourth potential advantage is that using monitoring light at wavelengths that are, e.g., greater than the wavelengths initiating the curing process will not induce curing by the monitoring light. For example, dental composites that absorb light between 400-500 nm often include a photo-initiator that is typically a yellow compound that does not absorb light beyond about 500 nm. In such circumstances, visible monitoring light in the red to yellow portion of the visible light spectrum may be less likely to be absorbed and, therefore, available for reflection to visible light detector.

In a first aspect, one or more embodiments of a dental curing light system as described herein may include: a curing light source configured to emit curing light at one or more wavelengths in a range from 400 nm to 800 nm, the curing light having a curing wavelength of maximum emission (λ_{max-cure}), wherein curing of polymerizable dental material is induced by the curing light at the curing wavelength of maximum emission (λ_{max-cure}); a monitoring light source that emits visible monitoring light at the polymerizable dental material at one or more wavelengths in a range from 400 nm to 800 nm, the monitoring light having a monitoring wavelength of maximum emission (λₘₐₓ₋ₘₒₙ), wherein the monitoring wavelength of maximum emission (λₘₐₓ₋ₘₒₙ) does not effectively induce polymerization of the polymerizable dental material; a visible light detector configured to detect the monitoring light after the monitoring light is diffusely reflected by the polymerizable dental material; and a controller operably coupled to the visible light detector, wherein the controller is configured to determine when the polymerizable dental material reaches a selected degree of curing based at least in part on a selected rate of change in intensity of the diffusely reflected monitoring light detected by the visible light detector.

In one or more embodiments of a system as described herein, the controller is configured to stop the curing light source from emitting the curing light after determining that the polymerizable dental material has reached the selected degree of curing.

In one or more embodiments of a system as described herein, the controller is configured to stop the curing light source from emitting the curing light based at least in part on an output from the visible light detector.

In one or more embodiments of a system as described herein, the dental curing light system further comprises a feedback generator operably coupled to the controller, wherein the controller is configured to cause the sensory feedback generator to provide sensory feedback to a user after determining that the polymerizable dental material has reached the selected degree of curing.

In one or more embodiments of a system as described herein, the sensory feedback generator comprises one or both of a visual indicator and an audible/tactile indicator.

In one or more embodiments of a system as described herein, the dental curing light system comprises a filter configured to prevent light having the curing wavelength of maximum emission (λ_{max-cure}) from reaching the visible light detector.

In one or more embodiments of a system as described herein, the dental curing light system comprises a filter configured to allow only light that does not effectively induce polymerization of the polymerizable dental material to reach the visible light detector.

In one or more embodiments of a system as described herein, the dental curing light system further comprises a probe and a handle, wherein the curing light is emitted from the probe, and wherein the probe is configured for insertion into the oral cavity of a human.

In one or more embodiments of a system as described herein, the monitoring light is emitted from the probe.

In one or more embodiments of a system as described herein, the probe comprises a proximal end attached to the handle and distal end distal from the handle, and wherein the curing light source is emitted from an emitting surface at the distal end of the probe.

In one or more embodiments of a system as described herein, the monitoring light is emitted from the emitting surface at the distal end of the probe.

In one or more embodiments of a system as described herein, the visible light detector is optically coupled to the probe such that diffusely reflected monitoring light entering the probe is transmitted to the visible light detector.

In one or more embodiments of a system as described herein, any monitoring wavelength of maximum emission (λₘₐₓ₋ₘₒₙ) is at least 50 nm different from the curing wavelength of maximum emission (λ_{max-cure}) of the curing light.

In one or more embodiments of a system as described herein, the monitoring wavelength of maximum emission (λₘₐₓ₋ₘₒₙ) is at least 100 nm different from the curing wavelength of maximum emission (λ_{max-cure}) of the curing light.

In one or more embodiments of a system as described herein, the curing light comprises light at one or more wavelengths in a range from 400 nm to 500 nm.

In one or more embodiments of a system as described herein, the visible monitoring light comprises visible light at one or more wavelengths of 500 nm or more.

In one or more embodiments of a system as described herein, the visible monitoring light comprises visible light at one or more wavelengths of 550 nm or more.

In one or more embodiments of a system as described herein, the monitoring light emitted by the monitoring light source has, at the curing wavelength of maximum emission (λ_{max-cure}), an intensity of 0.1 or less of an intensity of the curing light at the curing wavelength of maximum emission (λ_{max-cure}).

In one or more embodiments of a system as described herein, the monitoring light source does not emit light at the curing wavelength of maximum emission (λ_{max-cure}).

In one or more embodiments of a system as described herein, the curing light source and the monitoring light source are coaxial.

In one or more embodiments of a system as described herein, the visible light detector does not detect light having the curing wavelength of maximum emission (λ_{max-cure}).

In one or more embodiments of a system as described herein, the visible monitoring light source emits monitoring light having an intensity such that the monitoring light is visible to the naked human eye after passing through the polymerizable dental material.

In one or more embodiments of a system as described herein, the visible monitoring light source emits collimated monitoring light.

In one or more embodiments of a system as described herein, the curing light source emits non-collimated curing light.

In one or more embodiments of a system as described herein, the dental curing light system comprises a mixing rod optically coupled to the curing light source and the monitoring light source, wherein the curing light and the monitoring light pass through the mixing rod before reaching the polymerizable dental material.

In one or more embodiments of a system as described herein, the visible light detector is optically coupled to the mixing rod, wherein the reflected monitoring light passes through the mixing rod before reaching the visible light detector.

In a second aspect, one or more embodiments of a method of monitoring a degree of cure of polymerizable dental material may include: irradiating the polyermizable dental material with curing light at one or more wavelengths ranging from 400 nm to 800 nm to cure the polymerizable dental material, the curing visible light having a wavelength of maximum emission (λ_{max-cure}), wherein the curing light at the curing wavelength of maximum emission (λ_{max-cure}) induces curing of the polymerizable dental material; irradiating the polymerizable dental material with visible monitoring light at one or more wavelengths in a range from 400 nm to 800 nm, the monitoring light having a monitoring wavelength of maximum emission (λₘₐₓ₋ₘₒₙ), wherein the monitoring light at the monitoring wavelength of maximum emission (λₘₐₓ₋ₘₒₙ) does not effectively induce polymerization of the polymerizable dental material; detecting the monitoring light after it has been diffusely reflected by the polymerizable dental material at one or more wavelengths in a range from 400 nm to 800 nm; and determining when the polymerizable dental material reaches a selected degree of curing based at least in part on a selected rate of change in intensity of the detected diffusely reflected monitoring light.

In one or more embodiments of a method as described herein, the method further comprises stopping the irradiation of polymerizable dental material with the curing light after determining that the polymerizable dental material has reached the selected degree of curing.

In one or more embodiments of a method as described herein, the method further comprises stopping the irradiation of polymerizable dental material with the curing light based at least in part on an output from a visible light detector detecting the monitoring light after it has been diffusely reflected by the polymerizable dental material.

In one or more embodiments of a method as described herein, the method further comprises provides sensory feedback to a user after determining that the polymerizable dental material has reached the selected degree of curing.

In one or more embodiments of a method as described herein, the sensory feedback comprises one or more of audible feedback, visual feedback, and tactile feedback.

In one or more embodiments of a method as described herein, the method comprises preventing light having the curing wavelength of maximum emission (λ_{max-cure}) from reaching a visible light detector detecting the monitoring light after it has been diffusely reflected by the polymerizable dental material.

In one or more embodiments of a method as described herein, the visible monitoring light irradiating the polymerizable dental material has an intensity, at the curing wavelength of maximum emission (λ_{max-cure}), of 0.1 or less of an intensity of the curing light at the curing wavelength of maximum emission (λ_{max-cure}).

In one or more embodiments of a method as described herein, the monitoring light does not include light at the curing wavelength of maximum emission (λ_{max-cure}).

In one or more embodiments of a method as described herein, the curing light and the monitoring light are emitted from a probe configured for insertion into the oral cavity of a human.

In one or more embodiments of a method as described herein, detecting the monitoring light after it has been diffusely reflected by the polymerizable dental material comprises detecting the diffusely reflected monitoring light after it has entered the probe.

In one or more embodiments of a method as described herein, the monitoring wavelength of maximum emission (λₘₐₓ₋ₘₒₙ) is at least 50 nm different from the curing wavelength of maximum emission (λ_{max-cure}) of the curing light.

In one or more embodiments of a method as described herein, the monitoring wavelength of maximum emission (λₘₐₓ₋ₘₒₙ) is at least 100 nm different from the curing wavelength of maximum emission (λ_{max-cure}) of the curing light.

In one or more embodiments of a method as described herein, the curing light comprises visible light at one or more wavelengths in a range from 400 nm to 500 nm.

In one or more embodiments of a method as described herein, the visible monitoring light comprises visible light at one or more wavelengths of 500 nm or more.

In one or more embodiments of a method as described herein, the visible monitoring light comprises visible light at one or more wavelengths of 550 nm or more.

In one or more embodiments of a method as described herein, the curing light has a full width at half maximum emission of 100 nm or less.

In one or more embodiments of a method as described herein, the monitoring light has a full width at half maximum emission of 100 nm or less.

In one or more embodiments of a method as described herein, the curing light and the monitoring light irradiating the polymerizable dental material are coaxial.

In one or more embodiments of a method as described herein, the monitoring light irradiates a smaller area of a surface of the polymerizable dental material than the curing light.

In one or more embodiments of a method as described herein, a monitoring area on a surface of the polymerizable dental material irradiated by the monitoring light and a curing area on the surface of the polymerizable dental material irradiated by the curing light are the same.

In one or more embodiments of a method as described herein, the visible monitoring light irradiating the polymerizable dental material is collimated light.

In one or more embodiments of a method as described herein, the curing light irradiating the polymerizable dental material is non-collimated light.

In one or more embodiments of a method as described herein, the monitoring light penetrates through an entire thickness of the polymerizable dental material

In one or more embodiments of a method as described herein, the monitoring light is visible to the naked human eye after passing through the polymerizable dental material.

In one or more embodiments of a method as described herein, the monitoring light passes through at least 4 mm of the polymerizable dental material.

In one or more embodiments of a method as described herein, the monitoring light passes through no more than 10 mm of the polymerizable dental material.

In one or more embodiments of a method as described herein, the polymerizable dental material comprises at least one selected from the group of photoinitiators, thermal initiators, chemical initiators, and catalysts.

In one or more embodiments of a method as described herein, the polymerizable dental material comprises a filler.

In one or more embodiments of a method as described herein, the polymerizable dental material comprises a polymerizable chemical moiety, and wherein the polymerizable chemical moiety does not absorb the monitoring light.

The above summary is not intended to describe each embodiment or every implementation of the systems and methods described herein. Rather, a more complete understanding of the invention will become apparent and appreciated by reference to the following Detailed Description and claims in view of the accompanying figures of the drawing.

### BRIEF DESCRIPTION OF THE DRAWING

The invention may be more completely understood and appreciated in consideration of the following detailed description of various embodiments of the invention in connection with the accompanying figures, in which:

FIG. 1 is a schematic block diagram of one illustrative embodiment of a dental curing light system as described herein.

FIG. 2 depicts one illustrative embodiment of the relative areas on which the curing light and visible monitoring light are incident on a surface.

FIG. 3 depicts another illustrative embodiment of the relative areas on which the curing light and visible monitoring light are incident on a surface.

FIG. 4 depicts one illustrative example of the degree of cure for a selected polymerizable dental material and time along the x-axis and diffuse reflectance along the y-axis.

FIG. 5 depicts one illustrative embodiment of a handheld dental curing light system as described herein.

FIG. 6 depicts one illustrative arrangement of structures for delivering curing light and visible monitoring light to polymerizable dental material, and for delivering reflected monitoring light to a detector in one illustrative embodiment of a dental curing light system as described herein.

FIG. 7 depicts another illustrative embodiment of a dental curing light system as described herein including a mixing rod configured to deliver both curing light and visible monitoring light to polymerizable dental material and for returning reflected monitoring light to a detector.

FIG. 8 depicts one illustrative arrangement of curing light sources and visible monitoring light sources in the dental curing light system of FIG. 8.

FIG. 9 depicts components in a system used as described in Examples 1-4 and the Comparative Example.

FIG. 10 is a plot of reflectance of the monitoring light measured by the light detector and B/T hardness data of Table 1 as discussed in Example 1.

FIG. 11 is a plot of the B/T ratio versus normalized reflectance for Example 1.

FIG. 12 is a plot of reflectance of the monitoring light measured by the light detector and B/T hardness data for Example 2.

FIG. 13 is a plot of the B/T ratio versus normalized reflectance for Example 2.

FIG. 14 is a plot of reflectance of the monitoring light measured by the light detector and B/T hardness data for Example 3.

FIG. 15 is a plot of the B/T ratio versus normalized reflectance for Example 3.

FIG. 16 depicts normalized monitoring light reflectance data and B/T hardness data collected in Example 4.

FIG. 17 is a plot of reflectance of blue 450 nm curing light measured by the light detector and B/T hardness data as collected in the Comparative Example.

FIG. 18 is a plot of the B/T ratio versus normalized reflectance for the Comparative Example.

### DETAILED DESCRIPTION

In the following description, reference is made to the accompanying figures of the drawing which form a part hereof, and in which are shown, by way of illustration, specific embodiments. It is to be understood that other embodiments may be utilized and structural changes may be made without departing from the scope of the present invention.

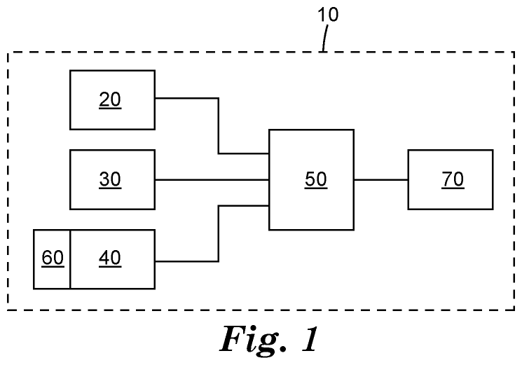

One illustrative embodiment of a dental curing light system is depicted in FIG. 1. The depicted system 10 includes a curing light source 20, a monitoring light source 30, a visible light detector 40, and a controller 50 operably connected, in the depicted embodiment, to each of the curing light source 20, monitoring light source 30, and visible light detector 40. In one or more embodiments of the systems described herein, the curing light source 20 may be optional. The depicted system 10 also includes an optional filter 60 configured to control light/electromagnetic radiation allowed to reach the visible light detector 40. The controller 50 of the system 10 is also operably connected to an optional sensory feedback generator 70.

The curing light source 20 used in one or more embodiments of the systems described herein, may be configured to emit curing light having a curing wavelength of maximum emission, λ_{max-cure}, at which curing of selected polymerizable dental material is induced. In other words, the curing light emitted by the curing light source 20 initiates polymerization of the selected polymerizable dental material at its λ_{max-cure}. In one or more embodiments, polymerization initiation of the selected polymerizable dental material by the curing light may also occur at one or more wavelengths on one or both sides of the curing wavelength of maximum emission λ_{max-cure}. In one or more embodiments, the curing light source 20 may emit light within a relatively narrow range of wavelengths.

In one or more embodiments, the curing light emitted by the curing light source 20 may have a full width, in terms of wavelengths, at half maximum emission of, e.g., 100 nm or less, 50 nm or less, 20 nm or less, 10 nm or less, or even 1 nm or less (where half maximum emission is half of the intensity as measured at the curing wavelengths of maximum emission, λ_{max-cure}. That full width can be referred to as the curing wavelength half-max range. In other words, if the curing wavelengths of maximum emission (λ_{max-cure}, e.g., 450 nm) have a normalized intensity of one, the curing wavelength half-max range over which the curing light source emits light with a normalized intensity of 0.5 or more occupies a range of 100 nm or less (or 50 nm or less, 20 nm or less, 10 nm or less, or even 1 nm or less) which contains the curing wavelengths of maximum emission (λ_{max-cure}). In such embodiments, the curing wavelengths of maximum emission (λ_{max-cure}) may or may not be centered within the curing wavelength half-max range. Further, the curing light may fall below an intensity of 0.5 within the curing wavelength half-max range so long as the widest range of wavelengths of the curing light has, at its outermost wavelengths, an intensity that is half of the intensity of the curing light at λ_{max-cure}. In other words, an intensity curve of the curing light may contain one or more local minimums within the curing wavelength half-max range.

In one or more embodiments, the curing light source 20 may be a visible light source that emits visible light at one or more wavelengths ranging from 400 nm to 800 nm. In one or more embodiments, the curing light source 20 may emit visible light in a narrower range. For example, in one or more embodiments, the curing light source 20 used in systems and/or methods described herein may emit visible light at one or more wavelengths ranging from, e.g., 400 nm to, e.g., 500 nm.

The curing light source 20 used in one or more embodiments of the systems and methods described herein can take any suitable form. Some potentially suitable curing light sources may include, e.g., halogen lamps, xenon lamps, arc lamps, LED's, LED emitters, LED dies, metal halide lamps, mercury vapor lamps, sodium lamps, lasers, etc. Delivery of the light emitted by the curing light source 20 to the polymerizable dental material may be accomplished using any suitable manner, e.g., light guides, wave guides, fiber optics, lenses, etc.

In one or more embodiments of the systems and/or methods described herein, the monitoring light source 30 may emit visible monitoring light at the polymerizable dental material at one or more wavelengths in a range from, e.g., 400 nm to, e.g., 800 nm. The monitoring light may, in one or more embodiments, have a monitoring wavelength of maximum emission, λₘₐₓ₋ₘₒₙ, that is different from the curing wavelength of maximum emission (λ_{max-cure}) of the curing light.

The monitoring light emitted by a monitoring light source in one or more embodiments of the systems and/or methods that include a curing light source as described herein may, at the curing wavelength of maximum emission (λ_{max-cure}), have an intensity of 0.1 or less of an intensity of the curing light emitted by the curing light source at the curing wavelength of maximum emission, λ_{max-cure}. In one or more alternative embodiments, the monitoring light source does not emit light at the curing wavelength of maximum emission, λ_{max-cure}.

In one or more embodiments, the monitoring wavelength of maximum emission may be at least 50 nm different from the curing wavelength of maximum emission of any curing light. In still one or more alternative embodiments, the monitoring light source 30 may emit visible monitoring light with a monitoring wavelength of maximum emission that is at least 100 nm different from the curing wavelength of maximum emission of the curing light. In other words, if the curing wavelength of maximum emission is at 450 nm, the monitoring wavelength of maximum emission may, in one or more embodiments, be 500 nm or more for a 50 nm difference or 550 nm or more for a 100 nm difference.

In one or more embodiments, the monitoring light source 30 may emit visible light within a relatively narrow range of wavelengths. In one or more embodiments, the monitoring light emitted by the monitoring light source 30 may have a full width, in terms of wavelengths, at half maximum emission of, e.g., 100 nm or less, 50 nm or less, 20 nm or less, 10 nm or less, or even 1 nm or less (where half maximum emission is half of the intensity of any monitoring wavelengths of maximum emission, λₘₐₓ₋ₘₒₙ). That full width can be referred to as the monitoring wavelength half-max range. In other words, if the monitoring wavelengths of maximum emission (λₘₐₓ₋ₘₒₙ, e.g., 650 nm) have a normalized intensity of one, the monitoring wavelength half-max range over which the monitoring light source emits light with a normalized intensity of 0.5 or more occupies a range of 100 nm or less (or 50 nm or less, 20 nm or less, 10 nm or less, or even 1 nm or less) which contains the monitoring wavelengths of maximum emission (λₘₐₓ₋ₘₒₙ). In such embodiments, the monitoring wavelengths of maximum emission (λₘₐₓ₋ₘₒₙ) may or may not be centered within the monitoring wavelength half-max range. Further, the monitoring light may fall below an intensity of 0.5 within the monitoring wavelength half-max range so long as the widest range of wavelengths of the monitoring light has, at its outermost wavelengths, an intensity that is half of the intensity of the monitoring light at λₘₐₓ₋ₘₒₙ. In other words, an intensity curve of the monitoring light may contain one or more local minimums within the monitoring wavelength half-max range.

In one or more embodiments of the systems and methods described herein, any wavelengths of maximum emission λ_{max-cure}, of the curing light are not contained within the monitoring wavelength half-max range.

The monitoring light source 30 used in one or more embodiments of the systems and methods described herein can take any suitable form. Some potentially suitable visible monitoring light sources may include, e.g., halogen lamps, xenon lamps, arc lamps, LED's, LED emitters, LED dies, metal halide lamps, mercury vapor lamps, sodium lamps, lasers, etc. and associated components such as, e.g., filters, etc. needed to control the wavelengths of light delivered to the polymerizable dental material by the monitoring light source 30. Delivery of the monitoring light emitted by the monitoring light source 30 to the polymerizable dental material may be accomplished using any suitable manner, e.g., light guides, wave guides, fiber optics, lenses, etc.

In one or more embodiments, the monitoring light source emits monitoring light with sufficient intensity (e.g., 1 mW, etc.) to penetrate the entire thickness of the polymerizable dental material being monitored for curing. If the monitoring light cannot penetrate the entire thickness of the polymerizable dental material, then an accurate determination of the degree of curing of the full thickness of the polymerizable dental material may not be obtained using the systems and methods described herein. As discussed herein, a variety of potential light sources may be suitable, however, the use of collimated and/or coherent light sources such as, e.g., lasers, laser LEDs, etc. may provide monitoring light that has intensities capable of providing the most desirable outcomes.

In one or more embodiments of the systems and/or methods described herein, the monitoring light source may emit monitoring light having an intensity such that the monitoring light is visible to the naked human eye after passing through the polymerizable dental material. In other words, in a system and/or method in which the visible monitoring light is incident on a first surface of the polymerizable dental material, that visible monitoring light may be seen in an unlit darkroom by the naked human eye on a surface of the polymerizable dental material located on an opposite side of the polymerizable dental material after having passed through the thickness of the polymerizable dental material.

In one or more embodiments, the intensity of the monitoring light may be sufficient to pass through at least 4 mm of the polymerizable dental material being monitored (where, for example, the polymerizable dental material is a dental polymerizable dental material used for tooth restoration and/or formation). In one or more alternative embodiments, the intensity of the monitoring light may be sufficient to pass through at least 4.5 mm, 5 mm, 6 mm, or 7 mm of the polymerizable dental material being monitored where, for example, the polymerizable dental material is used for tooth restoration and/or formation.

The intensity of the monitoring light may also, in one or more embodiments be controlled such that it does not exceed a selected limit. Limiting intensity of the monitoring light may be useful where monitoring light intensity above certain limits may adversely affect tissue in, e.g., the oral cavity and/or present other safety considerations. For example, in one or more embodiments, the intensity of the monitoring light may be sufficient to pass through no more than 10 mm of the polymerizable dental material being monitored where, for example, the polymerizable dental material is used for tooth restoration/formation. In one or more alternative embodiments, the intensity of the monitoring light may be sufficient to pass through no more than 9 mm, 8 mm, 7 mm, 6 mm, or 5 mm of the polymerizable dental material being monitored where, for example, the polymerizable dental material is used for tooth restoration/formation).

In one or more embodiments of the systems described herein, the curing light source and monitoring light source may emit light along the same propagation axis (see, e.g., propagation axis 111 in FIG. 5). In one or more alternative embodiments, the curing light source and the monitoring light source may emit along two different propagation axes. In one or more embodiments, those propagation axes for the curing light and the monitoring light may converge at a selected distance from the curing light source and the monitoring light source.

As discussed herein, the visible monitoring light may, in one or more embodiments, provide a visual aid to a user delivering curing light to a polymerizable dental material to assist with proper curing. In one or more embodiments of the systems and methods described herein, the visible monitoring light delivered by a monitoring light source may be collimated or otherwise controlled/focused to provide coverage, on a surface of the polymerizable dental material, over a selected monitoring area relative to the curing area to which the curing light is delivered.

FIGS. 2 and 3 depict two examples of the many possible relationships between monitoring area and the curing area on the surface of the polymerizable dental material over which monitoring light and/or curing light may be delivered in one or more embodiments of the systems and methods described herein. As seen in, e.g., FIG. 2, the monitoring light may be focused to a monitoring area 32 that is smaller than the curing area 22 over which the curing light is delivered while FIG. 3 depicts an arrangement in which the monitoring light is delivered to a monitoring area 32 that is the same as the curing area 22 on which the curing light is incident (where “the same” means that the monitoring area and the curing area differ from each other by no more than 5%). The size of the monitoring area 32 occupied by the monitoring light relative to the curing area 22 defined by the curing light may, in one or more embodiments, be selectively adjustable by, e.g., focusing, defocusing, collimating, de-collimating, etc.

In one or more embodiments of the systems described herein, the visible light detector 40 may be configured to detect monitoring light emitted by the monitoring light source. In one or more embodiments, that reflected monitoring light may be diffusely reflected from the polymerizable dental material and, as described herein, its detection may allow for monitoring a degree of curing of the polymerizable dental material by, e.g., curing light. In one or more embodiments, the monitoring light diffusely reflected by the polymerizable dental material may be detected by the visible light detector 40 while the curing light is incident on the polymerizable dental material. In one or more embodiments, the visible light detector 40 may be configured to detect light in a range from 400 nm to 800 nm.

To limit issues that may be associated with detection of the curing light by the visible light detector, in one or more embodiments the visible light detector may be in the form of a detector that does not detect light having the curing wavelengths of maximum emission, λ_{max-cure}. In one or more alternative embodiments, the visible light detectors used in the systems and/or methods described herein may not detect light falling within a curing wavelength half-max range as defined herein.

In place of and/or in addition to using visible light detectors that do not detect curing light to detect the reflected monitoring light, one or more embodiments of the systems and/or methods described herein may include one or more filters (see, e.g., filter 60 in FIG. 1) to filter light and/or light allowed to reach the visible light detectors. In one or more embodiments, the filter 60 may not allow light having any curing wavelengths of maximum emission, λ_{max-cure}, to pass through to reach the visible light detector 40. In one or more alternative embodiments, the filter 60 may not allow light falling within the curing wavelength half-max range as defined herein to pass through to reach the visible light detector. In one or more alternative embodiments, the filters or filtering used in the systems and/or methods described herein may allow only light that does not effectively induce polymerization of the polymerizable dental material to reach the visible light detector.

In one or more embodiments, the light detector 40 and/or filter 60 may be configured to detect at least light having the monitoring wavelengths of maximum emission, λₘₐₓ₋ₘₒₙ. In other words, the light detector 40 and/or filter 60 may be matched with the monitoring light source 30 such that at least the monitoring wavelengths of maximum emission, λₘₐₓ₋ₘₒₙ are detected by the light detector.

The monitoring light reflected from the polymerizable dental material can be measured by any suitable visible light detector technology. For example, any type of solid state sensing device such as, e.g., photodiodes, photo-detectors, phototransistors, analog light sensors, digital light sensors, frequency light sensors, etc. may be used. The visible light detectors used in one or more embodiments of the systems and methods described herein may generate a signal (for use by, e.g., a controller 50) that is proportional to the intensity of reflected light received from the polymerizable dental material. Collection and delivery of the reflected monitoring light to the visible light detectors used in the systems and methods described herein may be accomplished using any one or more refractive and/or reflective optical devices, e.g., lenses, mirrors, light guides, wave guides, fiber optics, etc.

In one or more embodiments, the visible monitoring light source 30 and the visible light detector 40 may be combined in one device such as, e.g., an LED driven in a pulsed mode in which an LED functions as a light source when driven and operates as a light detector when operated under currentless conditions.

In the illustrative embodiment depicted in FIG. 1, the system 10 includes a controller 50 that is operably connected to the curing light source 20, the monitoring light source 30, and the visible light detector 40. The controller 50 may also, in one or more embodiments, be operably connected to a sensory feedback generator 70 configured to generate feedback that can be sensed by a user of the systems and/or methods described herein. In one or more embodiments, the sensory feedback generators may be in the form of, e.g., one or more visual indicators and/or one or more audible/tactile indicators as discussed in connection with the illustrative system depicted in FIG. 5.

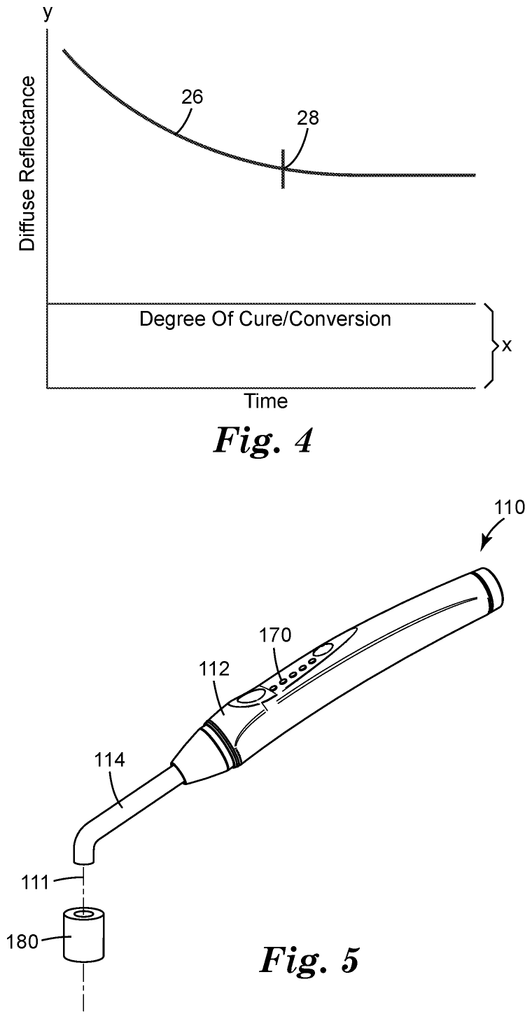

In one or more embodiments in which the controller 50 is operably coupled to the visible light detector 40, the controller 50 may be configured to determine when polymerizable dental material being monitored using monitoring light emitted by the monitoring light source 30 reaches a selected degree of curing based at least in part on a selected rate of change in the intensity of diffusely reflected monitoring light detected by the visible light detector 40. In one or more embodiments, the selected rate of change in intensity of the diffusely reflected monitoring light detected by the visible light detector will decrease as the degree of curing of polymerizable dental material increases. In other words, the rate of change in the intensity of the diffusely reflected monitoring light from adequately cured polymerizable dental material will be significantly lower than the rate of change in the intensity of the diffusely reflected monitoring light as seen at the start of a curing process when little to none of the polymerizable dental material is cured. One example illustrating degree of cure and time along the x-axis and diffuse reflectance along the y-axis is depicted in FIG. 4 as line 26 with point 28 positioned at a location at which the rate of change in intensity of the diffusely reflected monitoring light reaches a selected rate of change that can be correlated to a selected degree of curing of a selected polymerizable dental material as discussed herein.

In one or more embodiments in which the controller 50 is operably connected to the curing light source 20 and the visible light detector 40, the controller may be configured to stop the curing light source 20 from emitting curing light after based at least in part on an output from the visible light detector 40. That output from the visible light detector 40 may, in one or more embodiments, involve using a controller 50 that is configured to determine that the polymerizable dental material has reached the selected degree of curing as correlated to the selected rate of change in intensity of the diffusely reflected monitoring light. In such a situation, for example, the visible light detector 40 may output a signal to the controller 50 that is indicative of the intensity of the diffusely reflected monitoring light. Further, that signal from the visible light detector 40 changes as the intensity of the diffusely reflected monitoring light changes to provide data for the controller 50 to determine a rate of change in intensity of the diffusely reflected monitoring light which, as discussed herein, can be correlated to a selected degree of curing of the polymerizable dental material.

As discussed herein, one or more embodiments of the systems described herein may include a sensory feedback generator in the form of a visual indicator operably connected to the controller, with the controller configured to use the visual indicator to provide sensory feedback in the form of a visible indicator to a user of the system. In one or more embodiments, the visual indicator may be in the form of a light that, under control of the controller 50, does one or more of the following: turns on or off, flashes, changes color, changes intensity, etc. to provide a visible indication that the selected degree of curing of the polymerizable dental material has been reached. In one or more alternative embodiments, the sensory feedback generator in the form of a visual indicator could be provided in the form of a visual indicator on a display device (e.g., one or more lights, icons, etc. on a graphical user interface (GUI), etc. found on, e.g., a screen of an LCD or other display) that is operably connected to the controller 50.

Other sensory feedback generators which may be operably connected to the controller 50 in one or more embodiments of the systems described herein may be used to provide sensory feedback other than visual feedback to a user of the system. The sensory feedback generators may, in one or more embodiments, be in the form or a speaker, buzzer, siren, etc. typically used to generate vibrations that are audible by the human ear. In one or more alternative embodiments, the sensory feedback generators may generate vibrations that are normally sensed tactilely by a human user (for example, a person holding a dental curing light).

In one or more embodiments, the controller 50 may be configured to use the sensory feedback generators to provide an indication to a user that a curing or polymerization process is not progressing or progressing slower than required and/or preferred. In such situations, one or more of the sensory feedback generators may be used to provide sensory feedback that is different from that provided in situations where polymerization of the polymerizable dental material is progressing as expected and/or desired. In such systems and/or methods, the user may then have an opportunity to correct the curing process, stop the curing process, etc.

In place of or in addition to the use of filtering and/or visible light detectors that do not detect light of a curing wavelength of maximum emission as described herein, one or more embodiments of the systems and/or methods described herein may use strobing of the monitoring light and/or any curing light. For example, the controller may, in one or more embodiments, cycle the monitoring light source on and off and detect reflected monitoring light only during the appropriate intervals. In one alternative, a curing light source may be cycled on and off with the visible light detector used to detected reflected light only when the curing light is not emitted. In still other systems and/or methods, both the monitoring light source and the curing light source may be strobed such that when one source is emitting light the other source is not. In strobed systems and/or methods, filtering of the light reaching the detector may not be needed.

The controllers used in the systems described herein may be provided in any suitable form and may, for example, include a processing unit and optionally memory. In one or more embodiments, the processing unit of a controller may, for example, be in the form of one or more microprocessors, Field-Programmable Gate Arrays (FPGA), Digital Signal Processors (DSP), microcontrollers, Application Specific Integrated Circuit (ASIC) state machines, computing devices, etc. that may be integrated in a single piece of hardware or distributed in multiple pieces of hardware that can operatively communicate with one another.

The systems as described herein may, in one or more embodiments, include a monitoring light source that emits visible monitoring light, a visible light detector configured to detect the monitoring light reflected by polymerizable dental material, and one or both of a curing light source configured to emit curing light and a controller operably coupled to the visible light detector and, optionally, the curing light source. These various components may be incorporated into a variety of devices. In one or more embodiments, the monitoring light source and a visible light detector configured to detect the monitoring light reflected by polymerizable dental material may be incorporated into a unitary structure such as, e.g., a probe used in, for example, a dental curing light. In one or more embodiments, any such probe may also include components designed to deliver curing light from a curing light source that may also form a part of the same system.

The form of the systems described herein and/or used in the methods described herein may change based on the form of the polymerizable dental material to be monitored using visible light as discussed herein. For example, in one or more embodiments the polymerizable dental material may be in the form of a discrete mass such as, e.g., dental restorative material. In one or more alternative embodiments, the polymerizable dental material may be in the form of, e.g., a coating, layer, film, etc. One illustrative example of a dental curing light system is depicted in FIG. 5.

The illustrative system 110 of FIG. 5 includes a housing 112 that may contain, in one or more embodiments, a curing light source, monitoring light source, visible light detector, and controller in a handheld device that may be suitable for, e.g., curing and monitoring the degree of curing of polymerizable dental materials used for, e.g., dental restoration, etc. Although not depicted, the system 110 may include a power supply operably connected to any of the components requiring power (the power source may, in one or more embodiments, located in the housing 112).

The system 110 depicted in FIG. 5 also includes a probe 114 that may, in one or more embodiments, incorporate one or more light guides used to direct and deliver curing light (if any) and visible monitoring light to selected polymerizable dental material 180. In one or more embodiments, the curing light and/or the monitoring light may be delivered to the polymerizable dental material 180 along propagation axis 111. The probe 114 may also include a light guide configured to collect reflected monitoring light and deliver it to a visible light detector of the system 110 (which may, for example, be located in the housing 112). In one or more alternative embodiments, the probe 114 may itself carry one or more of the components such as the curing light source, monitoring light source and/or visible light detector. In one or more embodiments, the probe 114 may be sized for placement in the oral cavity of a subject to, e.g., cure polymerizable dental material in vivo.

The illustrative system 110 may include one or more sensory feedback generators to provide feedback that can be sensed by a user of the system 10. In the depicted embodiment, the sensory feedback generators may include one or more visual indicators 170 and/or one or more audible/tactile indicators (e.g., speakers, vibration units, etc.—not depicted in FIG. 5). In one or more embodiments, the sensory feedback is delivered to be sensed by a user to provide an indication regarding the degree of curing of polymerizable dental material and/or if a selected degree of curing of the polymerizable dental material has been reached.

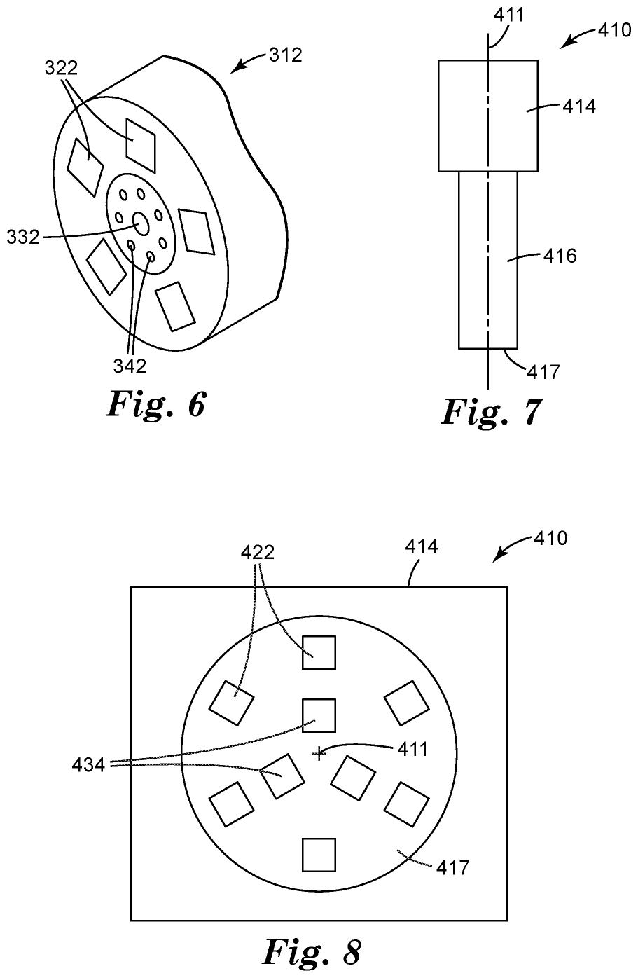

One illustrative embodiment of a probe 312 that may be used in one or more embodiments of a system as described herein is depicted in FIG. 6. The depicted embodiment of probe 312 may include an optical transmitter (e.g., an optical mixing rod, total internally reflective (TIR) light guide, etc.) that is optically coupled to LEDs 322 that serve as curing light sources configured to emit curing light for selected polymerizable dental material as discussed herein. It should be understood that the depicted LEDs 322 are arranged in one selected array, but that many more arrays could be used for arranging multiple curing light sources on a probe of a system as described herein. Furthermore, although five LEDs 322 are depicted in FIG. 6, one or more alternative embodiments of systems described herein may include as few as one curing light source or any other selected number of curing light sources as needed to provide curing light over a desired area and at desired intensities needed to polymerize the selected polymerizable dental material.

Probe 312 also includes the distal end of a visible monitoring light source transmitter 342 that is configured to emit visible monitoring light produced by a visible monitoring light source which may be located in, for example, a housing to which the probe 312 is attached. The transmitter 342 may take a variety of different forms as described herein such as, e.g., a fiber-optic cable, a fiber-optic cable bundle, light guide, etc. further, the transmitter 342 may include a lens at its distal end to control dispersion of the visible monitoring light. Further, although only one visible light source transmitter 342 is depicted in the illustrative embodiment of FIG. 6, it should be understood that one or more alternative embodiments of a probe 312 used in a system as described herein may include two or more visible monitoring light source transmitters arranged in any suitable format. Furthermore, the probe 312 may include the monitoring light source or sources themselves if, for example, the monitoring light source is provided in the form of an LED or other construction capable of being contained on the distal end of a probe 312.

The depicted illustrative embodiment of probe 312 also includes visible light collectors 332 configured to detect the monitoring light reflected by polymerizable dental material as described herein. The visible light collectors 332 may be optically coupled to one or more visible light detectors which may be located in, for example, a housing to which the probe 312 is attached. The visible light collectors 332 may take a variety of different forms as described herein such as, e.g., fiber-optic cables, light guides, etc. Further, the number of visible light collectors 332 used in systems as described herein may vary from as few as one collector to any selected number of collectors suitable to collect and transmit monitoring light reflected from the polymerizable dental material in systems and methods as described herein.

Another illustrative embodiment of a dental curing light system as described herein is depicted in connection with FIGS. 7 and 8. The system 410 as seen in FIG. 7 includes a housing 414 and a mixing rod 416. In one or more embodiments, the mixing rod 416 is configured to mix and deliver light emitted by one or more curing light sources and visible light emitted by one or more visible monitoring light sources, with the curing light sources and the visible monitoring light sources located in the housing 414. In one or more embodiments, the mixing rod 416 may be optically coupled to the curing light source and the monitoring light source in the housing 414 such that the curing light and the monitoring light pass through the mixing rod 416 before reaching polymerizable dental material. In one or more embodiments, the visible light detector in the housing 414 is also optically coupled to the mixing rod 416 such that reflected monitoring light passes through the mixing rod 416 before reaching the visible light detector in the housing 414.

In one or more embodiments, the mixing rod 416 may be constructed of any suitable optically transmissive material such as, e.g., glass, polymers (e.g., polycarbonate, etc.), etc. Furthermore, curing light and visible monitoring light may travel through the mixing rod 416 along the direction of propagation axis 411 and exit the mixing rod 416 at an end face 417.

One potential benefit of a system using a mixing rod to deliver both curing light as well as visible monitoring light is that it may be possible to deliver the monitoring light in a manner such that the monitoring light and the curing light occupy the same area on a surface on which they are directed, e.g., polymerizable dental material. In such an instance, the areas occupied by the curing light and the monitoring light may be similar to those seen in, e.g., FIG. 3 (described above).

The dental curing light system 410 of FIG. 7 is seen in a view taken along the propagation axis 411 in FIG. 8. In that view, the curing light sources 422 along with the visible monitoring light sources 434 are seen through the end face 417 of mixing rod 416. Both of the curing light sources 422 and the visible monitoring light sources 434 may, in the depicted embodiment, be in the form of LEDs. In particular, one or more of the visible monitoring light sources 434 may be LEDs that are driven in a pulsed mode. As a result, one or more of the pulsed mode LEDs serving as visible monitoring light sources 434 may also function as visible light detectors to detect monitoring light reflected by polymerizable dental material as discussed herein. In one or more embodiments, the curing light sources 422 and visible monitoring light sources 434 may be pulsed such that curing light is emitted by the curing light sources 422 while the monitoring light sources 434 do not emit visible monitoring light to reduce potential interference between the curing light sources and the monitoring light sources and the light detector 414.

### ILLUSTRATIVE EMBODIMENTS

The systems and methods described herein may be described in one or more of the following illustrative, non-limiting embodiments.

### Embodiment 1

A dental curing light comprising: a curing light source configured to emit curing light at one or more wavelengths in a range from 400 nm to 800 nm, the curing light having a curing wavelength of maximum emission (λ_{max-cure}), wherein curing of polymerizable dental material is induced by the curing light at the curing wavelength of maximum emission (λ_{max-cure}); a monitoring light source that emits visible monitoring light at the polymerizable dental material at one or more wavelengths in a range from 400 nm to 800 nm, the monitoring light having a monitoring wavelength of maximum emission (λₘₐₓ₋ₘₒₙ), wherein the monitoring wavelength of maximum emission (λₘₐₓ₋ₘₒₙ) does not effectively induce polymerization of the polymerizable dental material; a visible light detector configured to detect the monitoring light after the monitoring light is diffusely reflected by the polymerizable dental material; and a controller operably coupled to the visible light detector, wherein the controller is configured to determine when the polymerizable dental material reaches a selected degree of curing based at least in part on a selected rate of change in intensity of the diffusely reflected monitoring light detected by the visible light detector.

### Embodiment 2

A dental curing light system according to embodiment 1, wherein the controller is configured to stop the curing light source from emitting the curing light after determining that the polymerizable dental material has reached the selected degree of curing.

### Embodiment 3

A dental curing light system according to embodiment 1, wherein the controller is configured to stop the curing light source from emitting the curing light based at least in part on an output from the visible light detector.

### Embodiment 4

A dental curing light system according to any one of embodiments 1 to 3, wherein the dental curing light system further comprises a feedback generator operably coupled to the controller, wherein the controller is configured to cause the sensory feedback generator to provide sensory feedback to a user after determining that the polymerizable dental material has reached the selected degree of curing.

### Embodiment 5

A dental curing light system according to embodiment 4, wherein the sensory feedback generator comprises one or both of a visual indicator and an audible/tactile indicator.

### Embodiment 6

A dental curing light system according to any one of embodiments 1 to 5, wherein the dental curing light system comprises a filter configured to prevent light having the curing wavelength of maximum emission (λ_{max-cure}) from reaching the visible light detector.

### Embodiment 7

A dental curing light system according to any one of embodiments 1 to 6, wherein the dental curing light system comprises a filter configured to allow only light that does not effectively induce polymerization of the polymerizable dental material to reach the visible light detector.

### Embodiment 8

A dental curing light system according to any one of embodiments 1 to 7, wherein the dental curing light system further comprises a probe and a handle, wherein the curing light is emitted from the probe, and wherein the probe is configured for insertion into the oral cavity of a human.

### Embodiment 9

A dental curing light system according to embodiment 8, wherein the monitoring light is emitted from the probe.

### Embodiment 10

A dental curing light system according to any one of embodiments 8 to 9, wherein the probe comprises a proximal end attached to the handle and distal end distal from the handle, and wherein the curing light source is emitted from an emitting surface at the distal end of the probe.

### Embodiment 11

A dental curing light system according to embodiment 10, wherein the monitoring light is emitted from the emitting surface at the distal end of the probe.

### Embodiment 12

A dental curing light system according to any one of embodiments 8 to 11, wherein the visible light detector is optically coupled to the probe such that diffusely reflected monitoring light entering the probe is transmitted to the visible light detector.

### Embodiment 13

A dental curing light system according to any one of embodiments 1 to 12, wherein any monitoring wavelength of maximum emission (λₘₐₓ₋ₘₒₙ) is at least 50 nm different from the curing wavelength of maximum emission (λ_{max-cure}) of the curing light.

### Embodiment 14

A dental curing light system according to any one of embodiments 1 to 12, wherein the monitoring wavelength of maximum emission (λₘₐₓ₋ₘₒₙ) is at least 100 nm different from the curing wavelength of maximum emission (λ_{max-cure}) of the curing light.

### Embodiment 15

A dental curing light system according to any one of embodiments 1 to 14, wherein the curing light comprises light at one or more wavelengths in a range from 400 nm to 500 nm.

### Embodiment 16

A dental curing light system according to any one of embodiments 1 to 15, wherein the visible monitoring light comprises visible light at one or more wavelengths of 500 nm or more.

### Embodiment 17

A dental curing light system according to any one of embodiments 1 to 16, wherein the visible monitoring light comprises visible light at one or more wavelengths of 550 nm or more.

### Embodiment 18

A dental curing light system according to any one of embodiments 1 to 17, wherein the monitoring light emitted by the monitoring light source has, at the curing wavelength of maximum emission (λ_{max-cure}), an intensity of 0.1 or less of an intensity of the curing light at the curing wavelength of maximum emission (λ_{max-cure}).

### Embodiment 19

A dental curing light system according to any one of embodiments 1 to 17, wherein the monitoring light source does not emit light at the curing wavelength of maximum emission (λ_{max-cure}).

### Embodiment 20

A dental curing light system according to any one of embodiments 1 to 19, wherein the curing light source and the monitoring light source are coaxial.

### Embodiment 21

A dental curing light system according to any one of embodiments 1 to 20, wherein the visible light detector does not detect light having the curing wavelength of maximum emission (λ_{max-cure}).

### Embodiment 22

A dental curing light system according to any one of embodiments 1 to 21, wherein the visible monitoring light source emits monitoring light having an intensity such that the monitoring light is visible to the naked human eye after passing through the polymerizable dental material.

### Embodiment 23

A dental curing light system according to any one of embodiments 1 to 22, wherein the visible monitoring light source emits collimated monitoring light.

### Embodiment 24

A dental curing light system according to any one of embodiments 1 to 23, wherein the curing light source emits non-collimated curing light.

### Embodiment 25

A dental curing light system according to any one of embodiments 1 to 24, wherein the dental curing light system comprises a mixing rod optically coupled to the curing light source and the monitoring light source, wherein the curing light and the monitoring light pass through the mixing rod before reaching the polymerizable dental material.

### Embodiment 26

A dental curing light system according to embodiment 25, wherein the visible light detector is optically coupled to the mixing rod, wherein the reflected monitoring light passes through the mixing rod before reaching the visible light detector.

### Embodiment 27

A method of monitoring a degree of cure of polymerizable dental material, the method comprising: irradiating the polyermizable dental material with curing light at one or more wavelengths ranging from 400 nm to 800 nm to cure the polymerizable dental material, the curing visible light having a wavelength of maximum emission (λ_{max-cure}), wherein the curing light at the curing wavelength of maximum emission (λ_{max-cure}) induces curing of the polymerizable dental material; irradiating the polymerizable dental material with visible monitoring light at one or more wavelengths in a range from 400 nm to 800 nm, the monitoring light having a monitoring wavelength of maximum emission (λₘₐₓ₋ₘₒₙ), wherein the monitoring light at the monitoring wavelength of maximum emission (λₘₐₓ₋ₘₒₙ) does not effectively induce polymerization of the polymerizable dental material; detecting the monitoring light after it has been diffusely reflected by the polymerizable dental material at one or more wavelengths in a range from 400 nm to 800 nm; and determining when the polymerizable dental material reaches a selected degree of curing based at least in part on a selected rate of change in intensity of the detected diffusely reflected monitoring light.

### Embodiment 28

A method according to embodiment 27, wherein the method further comprises stopping the irradiation of polymerizable dental material with the curing light after determining that the polymerizable dental material has reached the selected degree of curing.

### Embodiment 29

A method according to embodiment 27, wherein the method further comprises stopping the irradiation of polymerizable dental material with the curing light based at least in part on an output from a visible light detector detecting the monitoring light after it has been diffusely reflected by the polymerizable dental material.

### Embodiment 30

A method according to any one of embodiments 27 to 29, wherein the method further comprises provides sensory feedback to a user after determining that the polymerizable dental material has reached the selected degree of curing.

### Embodiment 31

A method according to embodiment 30, wherein the sensory feedback comprises one or more of audible feedback, visual feedback, and tactile feedback.

### Embodiment 32

A method according to any one of embodiments 27 to 31, wherein the method comprises preventing light having the curing wavelength of maximum emission (λ_{max-cure}) from reaching a visible light detector detecting the monitoring light after it has been diffusely reflected by the polymerizable dental material.

### Embodiment 33

A method according to any one of embodiments 27 to 32, wherein the visible monitoring light irradiating the polymerizable dental material has an intensity, at the curing wavelength of maximum emission (λ_{max-cure}), of 0.1 or less of an intensity of the curing light at the curing wavelength of maximum emission (λ_{max-cure}).

### Embodiment 34

A method according to any one of embodiments 27 to 32, wherein the monitoring light does not include light at the curing wavelength of maximum emission (λ_{max-cure}).

### Embodiment 35

A method according to any one of embodiments 27 to 34, wherein the curing light and the monitoring light are emitted from a probe configured for insertion into the oral cavity of a human.

### Embodiment 36

A method according to embodiment 35, wherein detecting the monitoring light after it has been diffusely reflected by the polymerizable dental material comprises detecting the diffusely reflected monitoring light after it has entered the probe.

### Embodiment 37

A method according to any one of embodiments 27 to 36, wherein the monitoring wavelength of maximum emission (λₘₐₓ₋ₘₒₙ) is at least 50 nm different from the curing wavelength of maximum emission (λ_{max-cure}) of the curing light.

### Embodiment 38

A method according to any one of embodiments 27 to 36, wherein the monitoring wavelength of maximum emission (Amax-mon) is at least 100 nm different from the curing wavelength of maximum emission (λ_{max-cure}) of the curing light.

### Embodiment 39

A method according to any one of embodiments 27 to 38, wherein the curing light comprises visible light at one or more wavelengths in a range from 400 nm to 500 nm.

### Embodiment 40

A method according to any one of embodiments 27 to 39, wherein the visible monitoring light comprises visible light at one or more wavelengths of 500 nm or more.

### Embodiment 41

A method according to any one of embodiments 27 to 40, wherein the visible monitoring light comprises visible light at one or more wavelengths of 550 nm or more.

### Embodiment 42

A method according to any one of embodiments 27 to 41, wherein the curing light has a full width at half maximum emission of 100 nm or less.

### Embodiment 43

A method according to any one of embodiments 27 to 42, wherein the monitoring light has a full width at half maximum emission of 100 nm or less.

### Embodiment 44

A method according to any one of embodiments 27 to 43, wherein the curing light and the monitoring light irradiating the polymerizable dental material are coaxial.

### Embodiment 45

A method according to any one of embodiments 27 to 44, wherein the monitoring light irradiates a smaller area of a surface of the polymerizable dental material than the curing light.

### Embodiment 46

A method according to any one of embodiments 27 to 44, wherein a monitoring area on a surface of the polymerizable dental material irradiated by the monitoring light and a curing area on the surface of the polymerizable dental material irradiated by the curing light are the same.

### Embodiment 47

A method according to any one of embodiments 27 to 46, wherein the visible monitoring light irradiating the polymerizable dental material is collimated light.

### Embodiment 48

A method according to any one of embodiments 27 to 47, wherein the curing light irradiating the polymerizable dental material is non-collimated light.

### Embodiment 49

A method according to any one of embodiments 27 to 48, wherein the monitoring light penetrates through an entire thickness of the polymerizable dental material Embodiment 50. A method according to embodiment 49, wherein the monitoring light is visible to the naked human eye after passing through the polymerizable dental material.

### Embodiment 51

A method according to any one of embodiments 49 to 50, wherein the monitoring light passes through at least 4 mm of the polymerizable dental material.

### Embodiment 52

A method according to any one of embodiments 49 to 51, wherein the monitoring light passes through no more than 10 mm of the polymerizable dental material.

### Embodiment 53

A method according to any one of embodiments 27 to 52, wherein the polymerizable dental material comprises at least one selected from the group of photoinitiators, thermal initiators, chemical initiators, and catalysts.

### Embodiment 54

A method according to any one of embodiments 27 to 53, wherein the polymerizable dental material comprises a filler.

### Embodiment 55

A method according to any one of embodiments 27 to 54, wherein the polymerizable dental material comprises a polymerizable chemical moiety, and wherein the polymerizable chemical moiety does not absorb the monitoring light.

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the present invention and/or the scope of the appended claims.

Dental Curing Light System:

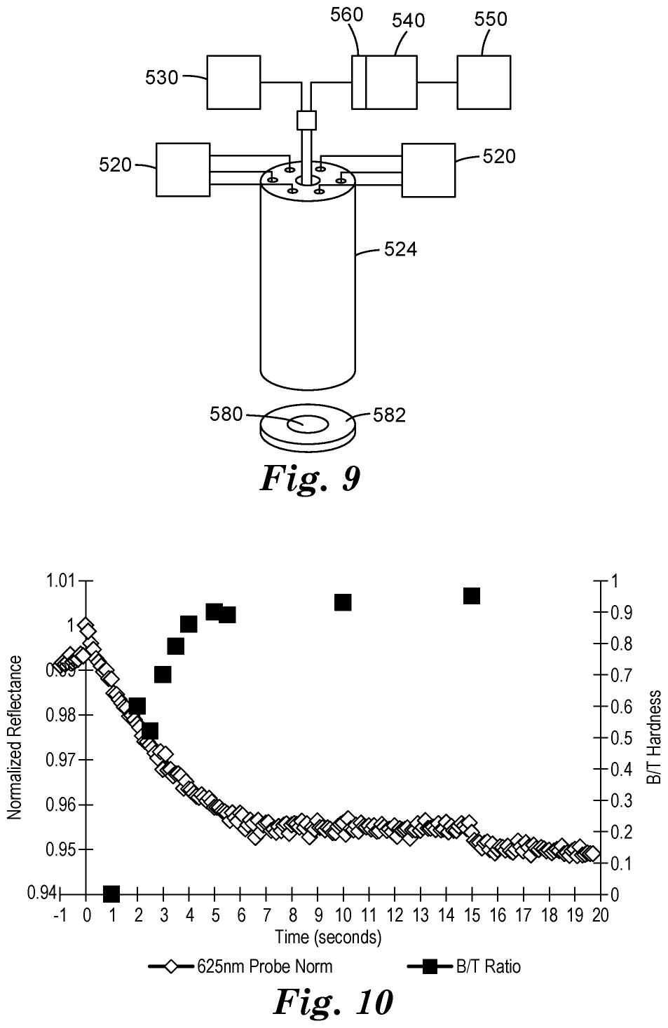

FIG. 9 depicts the system used to collect the data discussed below. Unless otherwise specified, a disc-shaped sample 580 of a selected polymerizable dental material was contained in a black washer 582 used as a mold. The top and bottom of the sample 580 were pressed flat.

The sample 580 was placed approximately 1 mm below a reflection probe 526 (Avantes, Apeldoorn, Netherlands, FCR-7 UVIR200-2-1.5X100). The reflection probe 526 contained six (6) light fibers optically coupled to a variety of different monitoring light sources 530 in the form of LEDs emitting monitoring light of different wavelengths as discussed in each of the examples. In each example, the monitoring LEDs were driven by a ThorLabs M4100 LED Driver (ThorLabs, Newton, N.J., USA).

The central read optical fiber of the reflection probe 526 was used to collect and deliver reflected monitoring light to a light detector 540 (Optoelectronics, Hawthorne, Calif., USA, PIN10DP). The reflected monitoring passed through a bandpass filter 560 appropriate for the monitoring wavelength in each example as discussed below (before reaching the light detector). The signal from the light detector was amplified (Stanford Research Systems, Sunnyvale, Calif., USA, SR570 Amplifier) and sent to a data acquisition computer 550. In each example, data from the light detector 540 was acquired at a rate of ten (10) samples per second and all data was normalized by dividing data points by the maximum mV reading.

The reflection probe 526 was located in a central bore of an acrylic light guide to which six 450 nm blue light emitting diodes 520 (LXZ1-PR01 Lumileds, San Jose, Calif., USA, LED—450 mA applied) were optically coupled to deliver curing light to the sample 580 through the light guide 524 surrounding the reflection probe 526.

Cure Definition:

The degree of curing of the samples was defined using the bottom to top (B/T) ratio of Barcol Hardness. The bottom Barcol Hardness was measured at the surface of the sample 580 that faced away from the reflection probe 526 and light guide 524. The top Barcol Hardness was measured at the surface of the sample 580 that faced the reflection probe 526 and light guide 524.

Barcol Hardness was determined according to the following procedure. After irradiation with curing light as discussed in each example, the hardness of the sample at both the top and the bottom of the mold was measured using a Barber-Coleman Impressor (a hand-held portable hardness tester; Model GYZJ 934-1; Barber-Coleman Company, Industrial Instruments Division, Lovas Park, Ind., USA) equipped with an indenter. Top and bottom Barcol Hardness values were measured within 1 minute of the termination of cure light exposure. The bottom to top ratios (B/T) were calculated (after at least some curing of the sample—noting that the B/T ratio before any curing would be the same as after complete curing) using, for a given cure light exposure time, the Bottom Hardness values divided by the arithmetic mean of all Top Hardness values at that cure light exposure time as set forth in the following equation:

(Bottom Hardness Value)/(Arithmetic Mean of Top Hardness Values)×100=B/T ratio

A sample of polymerizable dental material in the examples was deemed adequately cured when the B/T ratio reached 0.8 or above for a given exposure time.

### Example 1—Red 625 nm Monitoring Light

A sample of a polymerizable dental material in the form of Filtek Supreme Ultra shade A2B (3M Oral Care, St. Paul, Minn., USA) was contained in a black washer (McMaster-Carr, Elmhurst, Ill., USA, part#98029A029) used as a mold to provide a disc-shaped sample that was 3 mm thick and 7 mm in diameter. The sample and washer were placed on a black piece of plastic. Initially, the cure light (450 nm) exposure time was set to 1 second. After exposure to the cure light, the top and bottom Barcol Hardness was collected for each sample. This procedure was repeated for subsequent time points, preparing a new sample for each exposure time.

In this example, the monitoring light source 530 was a 625 nm red LED (ThorLabs, part# M625F1). The bandpass filter 560 used in connection with the light detector 540 was a 630 nm bandpass filter (ThorLabs, part# FB630-10). The 625 nm red LED monitoring light was turned on for approximately 5 seconds before the curing light LEDs were turned on to establish a baseline for the light detector. The sample was then exposed to the 450 nm blue curing light for 15 seconds while the monitoring light LED was simultaneously used to monitor cure. After 15 seconds the curing light was turned off, and approximately 5 seconds of continued exposure with the monitoring light was collected to establish a post-cure baseline. The data was collected as a millivolt (mV) signal from the photodetector 540. Data was normalized to the maximum mV reading and reported as normalized reflectance.

The results are outlined in Table 1. Each time point was replicated multiple times. The bottom to top ratio was calculated as described above. Table 1 is a compilation of the average B/T ratio and the standard deviation of the data points collected at each time point. Exposure times of 4 seconds or longer were adequately cured as defined above (i.e., such samples had a B/T ratio of 0.8 or higher).

TABLE 1
B/T Ratio as a Function of Time

| Exposure Time (s) | B/T Mean | StDev | N |
|---|---|---|---|
| 1 | 0% | 0.0% | 2 |
| 2 | 60% | 7.8% | 4 |
| 2.5 | 52% | 3.6% | 3 |
| 3 | 70% | 0.7% | 3 |
| 3.5 | 79% | 9.5% | 4 |
| 4 | 86% | 0.0% | 3 |
| 5 | 90% | 1.3% | 3 |
| 5.5 | 89% | 5.7% | 3 |
| 10 | 93% | 4.6% | 7 |
| 15 | 96% | 1.9% | 4 |
| 20 | 100% | 3.2% | 3 |

The graph of FIG. 10 is a plot of reflectance of the monitoring light measured by the light detector (with the 5 seconds of reflectance data collected before curing light exposure was truncated to one second). Overlaid on this graph is the B/T hardness data of Table 1. The graph of FIG. 10 demonstrates that the B/T hardness slows and/or stops changing at about 4 seconds (at the point of adequate curing) which correlates with the time that the change in reflectance of the monitoring light slows and/or stops.

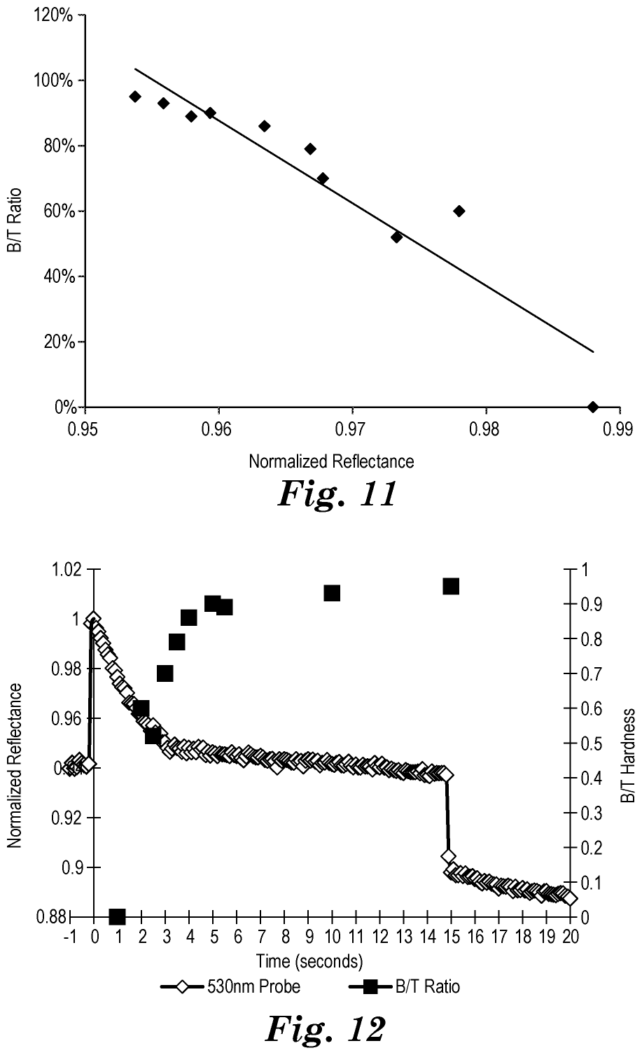

FIG. 11 is a plot of B/T ratio of this example versus the normalized reflectance. A linear relationship demonstrates a correlation between B/T ratio and reflectance of the monitoring light as detected by the light detector which is confirmed by a simple linear regression line drawn through the points with a resulting R-squared value of 0.9—demonstrating a predictive correlation between reflected monitoring light and adequate curing of the sample.

### Example 2—Green 530 nm Monitoring Light

The same process, apparatus, and materials used in Example 1 were used in Example 2, except that a 530 nm monitoring light LED (ThorLabs M530F1) was used in place of the 625 nm monitoring light LED of Example 1. In addition, the bandpass filter used with the light detector was changed to a 530 nm bandpass filter (Thorlabs FB530-10 bandpass).

The graph of FIG. 12 is a plot of reflectance of the monitoring light measured by the light detector (with the 5 seconds of reflectance data collected before curing light exposure truncated to one second). Overlaid on this graph is the B/T hardness data collected for Example 2. The graph of FIG. 12 demonstrates that the B/T hardness slows and/or stops changing at about 4 seconds (at the point of adequate curing) which correlates with the time that the change in reflectance of the monitoring light slows and/or stops.

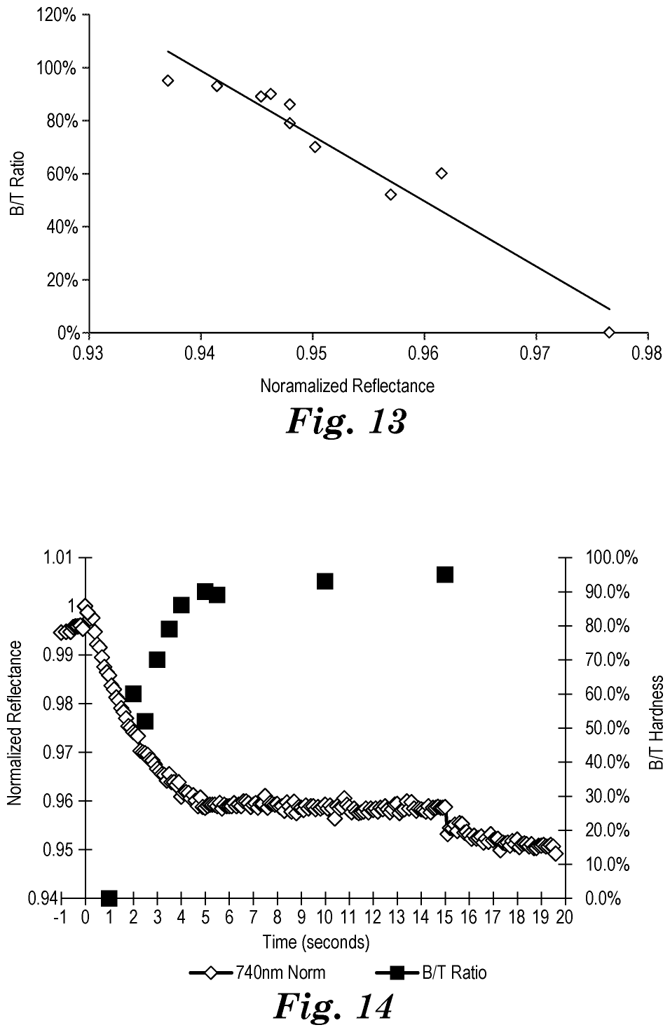

FIG. 13 is a plot of B/T ratio of this example versus the normalized reflectance. A linear relationship demonstrates a correlation between B/T ratio and reflectance of the monitoring light as detected by the light detector which is confirmed by a simple linear regression line drawn through the points with a resulting R-squared value of 0.9—again demonstrating a predictive correlation between reflected monitoring light and adequate curing of the sample.

### Example 3—Red 740 nm Monitoring Light

The same process, apparatus, and materials used in Example 1 were used in Example 2, except that a 740 nm monitoring light LED (ThorLabs M740F1) was used in place of the 625 nm monitoring light LED of Example 1. In addition, the bandpass filter used with the light detector was changed to a 740 nm bandpass filter (Thorlabs FB740-10 bandpass).

The graph of FIG. 14 is a plot of reflectance of the monitoring light measured by the light detector (with the 5 seconds of reflectance data collected before curing light exposure truncated to one second). Overlaid on this graph is the B/T hardness data collected for Example 3. The graph of FIG. 14 demonstrates that the B/T hardness slows and/or stops changing at about 4 seconds (at the point of adequate curing) which correlates with the time that the change in reflectance of the monitoring light slows and/or stops.

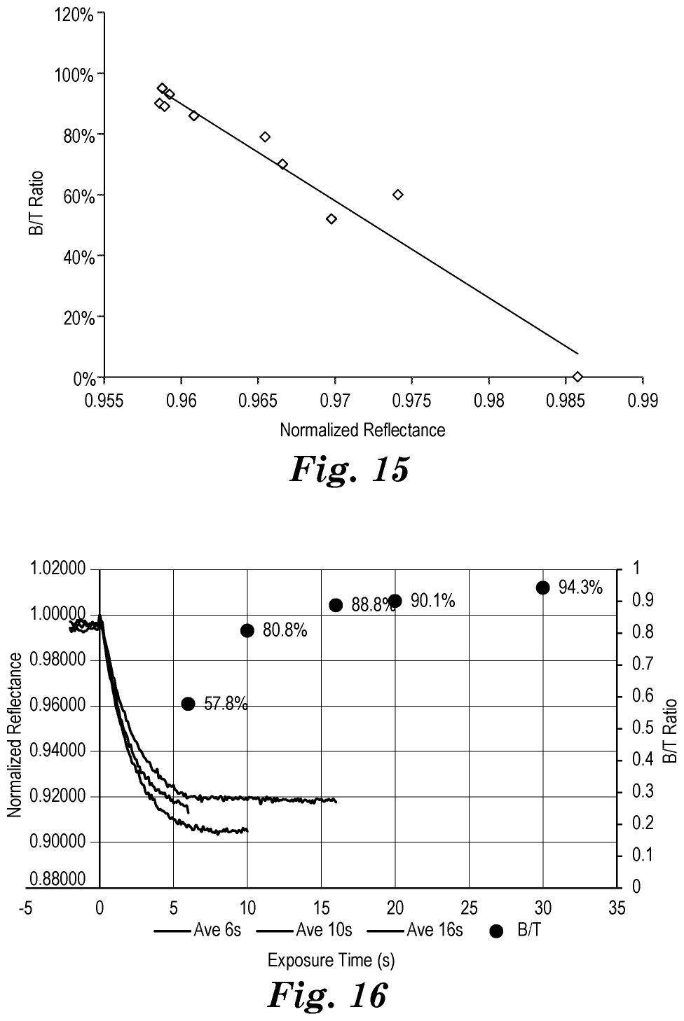

FIG. 15 is a plot of B/T ratio of this example versus the normalized reflectance. A linear relationship demonstrates a correlation between B/T ratio and reflectance of the monitoring light as detected by the light detector which is confirmed by a simple linear regression line drawn through the points with a resulting R-squared value of 0.9—again demonstrating a predictive correlation between reflected monitoring light and curing of the sample.

### Example 4—Depth of Monitoring Light Penetration

The apparatus described in FIG. 9 was used with the 740 nm red monitoring LED and 740 nm bandpass filter of Example 3. A 5 mm thick sample of polymerizable dental material in the form of Filtek Bulk Fill Posterior A2 shade (3M Oral Care, St. Paul, Minn., USA) was prepared in a black washer (McMaster-Carr, Elmhurst, Ill., USA, part#98099A029) as in Examples 1-3, except that the thickness of the sample was 5 mm. The sample and washer were placed on a white piece of plastic under the monitoring light, which was turned on for approximately 5 seconds to establish a baseline reading of reflectance from the light detector. The sample was then exposed to a 450 nm blue curing light as in Examples 1-3 for various times to cure. Simultaneously, the monitoring light (740 nm red) was used to monitor curing of the sample. After the 450 nm blue cure light was turned off, approximately 5 seconds of continued exposure with the monitoring light was used to establish a post cure baseline from the light detector. Triplicate measurements were made of each run, with the data from the three runs averaged.

Table 2 shows bottom to top (B/T) hardness ratios as a function of exposure time. B/T ratios for exposure to curing light for periods of 10 seconds or longer were adequately cured (i.e., had a B/T ratio of 0.8 or greater).

TABLE 2
B/T Ratio at Given Exposure Time

| Exposure Time (s) | B/T Mean | StDev | N |
|---|---|---|---|
| 6 | 57.8% | 10.7% | 3 |
| 10 | 80.8% | 1.5% | 3 |
| 16 | 88.8% | 1.5% | 3 |
| 20 | 90.1% | 3.6% | 3 |
| 30 | 94.3% | 0.0% | 3 |

The graph depicted in FIG. 16 shows normalized reflectance data of the sample of Example 4 after exposure to the curing light for 6, 10 and 16 seconds. The 5 seconds of pre-cure baseline data was truncated to 1 second and the post-cure baseline data is not shown. The B/T ratio shows that curing light exposure times of 10 seconds and longer yielded an adequately cured 5 mm thick sample. The reflectance curves each reach a steady state at the same time the sample is adequately cured as determined by the B/T hardness ratios.

Comparatively, the B/T ratio data collected for a curing light exposure of only 6 seconds shows that the sample has not adequately cured and this correlates with the failure of the reflectance curve to reach a steady state as seen in the graph of FIG. 16.

This data also demonstrates that the monitoring light is extending through the 5 mm thickness of the sample because the B/T ratio and the normalized reflectance are both reaching a steady state indicative of an adequately cured sample.

### Comparative Example

The same apparatus and sample material as used in Example 1 was used except that no monitoring light was used and no bandpass filter was used to limit the wavelength of light reaching the light detector. As a result, reflected curing light was detected by the light detector during the curing process.

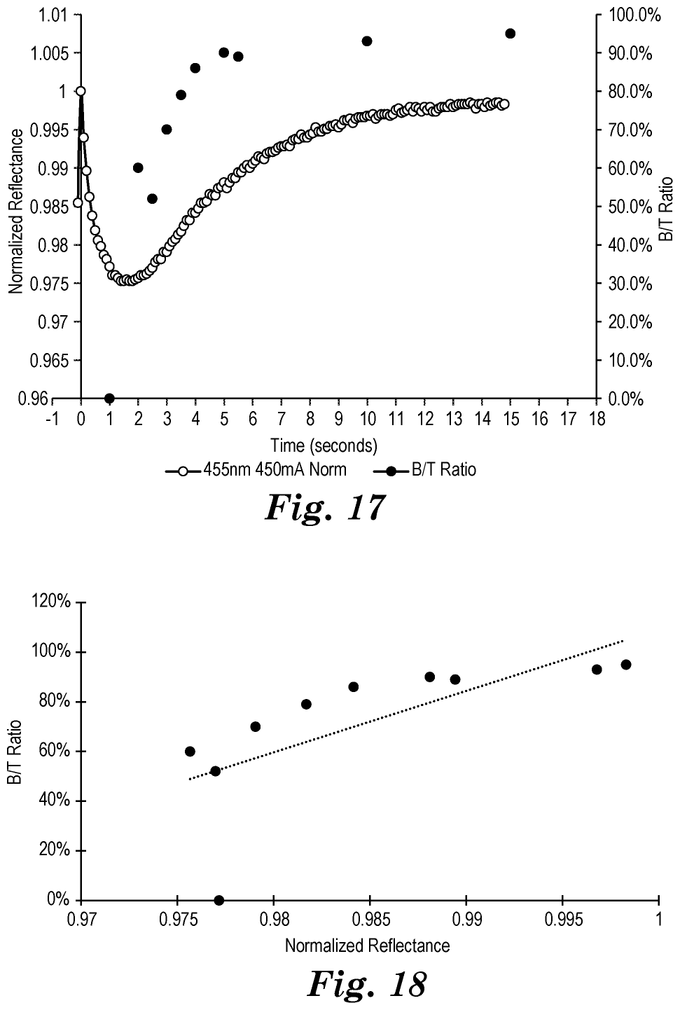

FIG. 17 is a graph depicting reflectance of the blue curing light as detected by the light detector for a 15 second exposure period. This graph demonstrates that the B/T ratio hardness curve stops changing at about 5 seconds (consistent with Example 1), while the reflectance curve continues to change for the remainder of the 15 second period. Unlike Examples 1-3, no distinctive part of the reflectance curve corresponds with a B/T ratio that defines adequate cure of the sample.

FIG. 18 is a plot of the B/T ratio versus normalized reflectance for this comparative example. A simple linear regression drawn through the points and the resulting R-squared value is 0.5—showing a poor correlation between reflected monitoring light and curing of the sample.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a system and/or method that “comprises” a list of elements (e.g., components or features or steps) is not necessarily limited to only those elements (or components or features or steps), but may include other elements (or components or features or steps) not expressly listed or inherent to the system and/or method.

As used herein, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed components or a combination of any two or more of the listed components.

As used herein, the transitional phrases “consists of” and “consisting of” exclude any element, step, or component not specified. For example, “consists of” or “consisting of” used in a preamble of a claim would limit the claim to the components or steps specifically recited in the claim. When the phrase “consists of” or “consisting of” appears in a clause of the body of a claim, rather than immediately following the preamble, the phrase “consists of” or “consisting of” limits only the components or steps set forth in that clause; other components or steps are not excluded from the claim as a whole.

The complete disclosure of the patents, patent documents, and publications identified herein are incorporated by reference in their entirety as if each were individually incorporated. To the extent there is a conflict or discrepancy between this document and the disclosure in any such incorporated document, this document will control.

From the above disclosure of the general principles of the present invention, the preceding detailed description, and the examples, those skilled in this art will readily comprehend the various modifications, re-arrangements and substitutions to which the present invention is susceptible, as well as the various advantages and benefits the present invention may provide. Therefore, the scope of the invention should be limited only by the following claims and equivalents thereof.

1. A dental curing light comprising:
a curing light source configured to emit curing light at one or more wavelengths in a range from 400 nm to 800 nm, the curing light having a curing wavelength of maximum emission (λ_{max-cure}), wherein curing of polymerizable dental material is induced by the curing light at the curing wavelength of maximum emission (λ_{max-cure});
a monitoring light source that emits visible monitoring light at the polymerizable dental material at one or more wavelengths in a range from 400 nm to 800 nm, the monitoring light having a monitoring wavelength of maximum emission (λₘₐₓ₋ₘₒₙ), wherein the monitoring wavelength of maximum emission (λₘₐₓ₋ₘₒₙ) does not effectively induce polymerization of the polymerizable dental material;
a visible light detector configured to detect the monitoring light after the monitoring light is diffusely reflected by the polymerizable dental material; and
a controller operably coupled to the visible light detector, wherein the controller is configured to determine when the polymerizable dental material reaches a selected degree of curing based at least in part on a selected rate of change in intensity of the diffusely reflected monitoring light detected by the visible light detector.

2. A dental curing light system according to claim 1, wherein the controller is configured to stop the curing light source from emitting the curing light after determining that the polymerizable dental material has reached the selected degree of curing.

3. A dental curing light system according to claim 1, wherein the controller is configured to stop the curing light source from emitting the curing light based at least in part on an output from the visible light detector.

4. A dental curing light system according to claim 1, wherein the dental curing light system further comprises a feedback generator operably coupled to the controller, wherein the controller is configured to cause the sensory feedback generator to provide sensory feedback to a user after determining that the polymerizable dental material has reached the selected degree of curing.

5. A dental curing light system according to claim 4, wherein the sensory feedback generator comprises one or both of a visual indicator and an audible/tactile indicator.

6. A dental curing light system according to claim 1, wherein the dental curing light system comprises a filter configured to prevent light having the curing wavelength of maximum emission (λ_{max-cure}) from reaching the visible light detector.

7. A dental curing light system according to claim 1, wherein the dental curing light system comprises a filter configured to allow only light that does not effectively induce polymerization of the polymerizable dental material to reach the visible light detector.

8. A dental curing light system according to claim 1, wherein the dental curing light system further comprises a probe and a handle, wherein the curing light is emitted from the probe, and wherein the probe is configured for insertion into the oral cavity of a human.

9. A dental curing light system according to claim 8, wherein the monitoring light is emitted from the probe.

10. A dental curing light system according to claim 8, wherein the probe comprises a proximal end attached to the handle and distal end distal from the handle, and wherein the curing light source is emitted from an emitting surface at the distal end of the probe.

11. A dental curing light system according to claim 10, wherein the monitoring light is emitted from the emitting surface at the distal end of the probe.

12. A dental curing light system according to claim 8, wherein the visible light detector is optically coupled to the probe such that diffusely reflected monitoring light entering the probe is transmitted to the visible light detector.

13. A dental curing light system according to claim 1, wherein any monitoring wavelength of maximum emission (λₘₐₓ₋ₘₒₙ) is at least 50 nm different from the curing wavelength of maximum emission (λ_{max-cure}) of the curing light.

14. A dental curing light system according to claim 1, wherein the monitoring wavelength of maximum emission (λₘₐₓ₋ₘₒₙ) is at least 100 nm different from the curing wavelength of maximum emission (λ_{max-cure}) of the curing light.

15. A dental curing light system according to claim 1, wherein the curing light comprises light at one or more wavelengths in a range from 400 nm to 500 nm.

16. A dental curing light system according to claim 1, wherein the visible monitoring light comprises visible light at one or more wavelengths of 500 nm or more.

17. A dental curing light system according to claim 1, wherein the visible monitoring light comprises visible light at one or more wavelengths of 550 nm or more.

18. A dental curing light system according to claim 1, wherein the monitoring light emitted by the monitoring light source has, at the curing wavelength of maximum emission (λₘₐₓ₋ₘₒₙ), an intensity of 0.1 or less of an intensity of the curing light at the curing wavelength of maximum emission (λ_{max-cure}).

19. A dental curing light system according to claim 1, wherein the monitoring light source does not emit light at the curing wavelength of maximum emission (λ_{max-cure}).

20. A dental curing light system according to claim 1, wherein the curing light source and the monitoring light source are coaxial.

21-55. (canceled)
